(19) United States
(12) Patent Application Publication
(10) Pub. No.: US 2024/0246222 A1
(43) Pub. Date: Jul. 25, 2024

(54) MOBILE ROBOT AND MOTION CONTROL SYSTEM

(71) Applicant: SAMSUNG ELECTRONICS CO., LTD., Suwon-si (KR)

(72) Inventors: Taegyu KIM, Suwon-si (KR); Minwoo RYU, Suwon-si (KR); Jihoon HA, Suwon-si (KR); Jinwook YOON, Suwon-si (KR); Euihyun JUNG, Suwon-si (KR)

(73) Assignee: SAMSUNG ELECTRONICS CO., LTD., Suwon-si (KR)

(21) Appl. No.: 18/525,123

(22) Filed: Nov. 30, 2023

Related U.S. Application Data
(63) Continuation of application No. PCT/KR2023/018605, filed on Nov. 20, 2023.

(30) Foreign Application Priority Data
Jan. 25, 2023 (KR) 10-2023-0009651

(51) Int. Cl. B25J 5/00; B60L 53/30; B60L 58/13

(52) U.S. Cl. CPC B25J 5/007; B60L 53/305; B60L 58/13

(57) ABSTRACT

Disclosed is a mobile robot including a main body, a plurality of antennas in the main body, and at least one processor configured to: receive, through the plurality of antennas, a communication signal from the charging station, obtain information about a distance between the charging station and the mobile robot and information about a direction from the mobile robot to the charging station based on the received communication signal, receive information about a position of the charging station from the charging station, and control docking of the mobile robot at the charging station based on the obtained information about the distance between the charging station and the mobile robot, the obtained information about a direction from the mobile robot to the charging station, and the received information about a position of the charging station.

### TECHNICAL FIELD

The disclosure relates to a mobile robot and motion control system to cut the grass in a working area while traveling in the working area and dock at a charging station after the mowing is done.

### BACKGROUND ART

Robots have been developed for industrial use and taken part of factory automation.

With the expansion of robot application fields these days, medical robots, aerospace robots, service robots, etc., have been developed and even home robots that may be used at home have also been developed.

Among these robots, a robot that is able to travel by itself is called a mobile robot. A classic example of the mobile robot is one that cuts and trims the grass in an outdoor environment of a house, a golf course or a playground.

For example, to cut the grass with the mobile robot in a working area, a person in charge lays a wire on a boundary of the working area. In this case, the mobile robot generates an inductive current through the coil and randomly travels in the working area while recognizing the wire by means of the inductive current.

In another example, the mobile robot recognizes location information of outer edges of the working area by communicating with a beacon installed in the working area, and travels in the working area based on the location information of the outer edges of the working area.

The mobile robot includes a plurality of wheels arranged in a lower portion of the main body and at least one blade arranged in the main body, travels in the working area by rotating the plurality of wheels and cuts the tops of the grass by rotating the at least one blade.

When the cutting of the grass in the working area is done or an amount of charge in the battery reaches a reference amount of charge or less, the mobile robot follows the perimeter wire installed in the working area to move to a charging station and arrives and docks at the charging station to charge the battery. In this case, docking of the mobile robot takes long time.

Moreover, the perimeter wire needs to be installed around the working area for docking between the mobile robot and the charging station, so it is cumbersome to install the perimeter wire and installing the perimeter wire requires some money and time.

### DISCLOSURE

### Technical Problem

The disclosure provides a mobile robot and motion control system to control traveling of the mobile robot so that a charging terminal of the mobile robot aligns with a charging terminal of a charging station during a docking operation.

The disclosure also provides a mobile robot and motion control system to correct information detected by an inertia sensor based on communication information from a plurality of beacons and a charging station at the time of departure from the charging station.

### Technical Solution

According to an embodiment of the disclosure, a mobile robot may include: a main body: a plurality of antennas in the main body: and at least one processor configured to: receive, through the plurality of antennas, a communication signal from a charging station, obtain information about a distance between the charging station and the mobile robot and information about a direction from the mobile robot to the charging station based on the received communication signal, receive information about a position of the charging station from the charging station, and control docking of the mobile robot at the charging station based on the obtained information about the distance between the charging station and the mobile robot, the obtained information about a direction from the mobile robot to the charging station, and the received information about a position of the charging station.

The plurality of antennas may be configured to: receive, from a plurality of beacons, a plurality of communication signals respectively corresponding to the plurality of beacons, and the at least one processor may be further configured to: set up a boundary of a working area, create a map of the working area, and recognize current location information of the mobile robot based on the received plurality of communication signals and the communication signal received from the charging station.

During the control of docking the at least one processor may be further configured to: determine, based on the recognized current location information of the mobile robot, whether the distance between the charging station and the mobile robot corresponds to a reference distance, control a rotation of the main body, based on the obtained information about the direction from the mobile robot to the charging station, to align the main body with the charging station by a time when the distance between the charging station and the mobile robot is determined to equal the reference distance, and control travel of the mobile robot based on the obtained information about the distance between the charging station and the mobile robot.

The mobile robot may further include: a first charging terminal in the main body: and a second charging terminal in the main body and spaced apart a first distance from the first charging terminal. The plurality of antennas may be arranged in a region between the first charging terminal and the second charging terminal, and in an area extending from the region between the first charging terminal and the second charging terminal.

The plurality of antennas may be disposed on an upper surface of the main body or protrude from the upper surface of the main body.

The plurality of antennas may include a first robot antenna, a second robot antenna, and a third robot antenna, the first robot antenna may be separated from each of the second robot antenna and the third robot antenna by a distance less than or equal to a half wavelength of an ultra-wideband communication frequency, and the second robot antenna and the third robot antenna may be arranged perpendicularly to each other with respect to the first robot antenna so that the first robot antenna, the second robot antenna, and the third robot antenna, may be disposed at vertices of a triangle.

The plurality of antennas may be configured to communicate with a plurality of beacons, and the at least one processor may be further configured to: determine that communication between the plurality of antennas and the plurality of beacons is not possible, and based on the determination: may receive, through the first robot antenna, the second robot antenna, and the third robot antenna, a plurality of communication signals from the charging station, and may recognize current location information of the mobile robot based on the received plurality of communication signals.

The mobile robot may further include a sensor configured to detect a motion of the main body. The plurality of antennas may be configured to communicate with a plurality of beacons. The at least one processor may be further configured to: determine that communication between the plurality of antennas and the plurality of beacons is not possible, and based on the determination: may receive, through the first robot antenna, the second robot antenna, and the third robot antenna, a plurality of communication signals from the charging station, may control a 360-degree rotation of the main body, and may correct sensing information detected by the sensor based on the received plurality of communication signals while controlling the 360-degree rotation of the main body.

The mobile robot may further include a sensor configured to detect a motion of the main body. The at least one processor may be further configured to: correct sensing information detected by the sensor based on the obtained information about the distance between the charging station and the mobile robot and the obtained information about the direction from the mobile robot to the charging station.

The mobile robot may further include a sensor configured to detect a motion of the main body. The plurality of antennas may be configured to communicate with a plurality of beacons, and the at least one processor may be further configured to: receive, through the plurality of antennas, a plurality of first communication signals respectively corresponding to the plurality of antennas from the charging station, receive, through the plurality of antennas, a plurality of second communication signals respectively corresponding to the plurality of beacons from the plurality of beacons, determine based on the received plurality of first communication signals and the received plurality of second communication signals whether the mobile robot has traveled a preset distance in a straight line from the charging station, and correct sensing information detected by the sensor based on the determination.

According to an embodiment of the disclosure, a motion control system may include: a charging station including a plurality of station antennas configured to transmit and/or receive one or more first communication signals for setting up a boundary of a working area and transmit position information of the charging station: a plurality of beacons configured to transmit and/or receive one or more second communication signals for setting up the boundary of the working area: and a mobile robot including a plurality of robot antennas configured to communicate with the charging station and the plurality of beacons, and travel in the working area, wherein the mobile robot may be configured to: receive, through the plurality of robot antennas, the one or more first communication signals from the charging station, obtain information about a distance between the charging station and the mobile robot and information about a direction from the mobile robot to the charging station based on the one or more received first communication signals, receive the position information of the charging station from the charging station, and control docking of the mobile robot at the docking station based on the obtained information about the distance between the charging station and the mobile robot, the obtained information about the direction from the mobile robot to the charging station, and the received position information of the charging station.

The mobile robot may be further configured to: receive, through the plurality of robot antennas, the one or more second communication signals respectively corresponding to the plurality of beacons, and set up the boundary of the working area, create a map of the working area, and recognize current location information of the mobile robot based on the received one or more second communication signals and the received one or more first communication signals.

During the control of docking the mobile robot may be further configured to: determine, based on the recognized current location information of the mobile robot, whether the distance between the charging station and the mobile robot corresponds to a reference distance, control a rotation of a main body of the mobile robot, based on the obtained information about the direction from the mobile robot to the charging station, to align the main body with the charging station by a time when the distance between the charging station and the mobile robot is determined to equal the reference distance, control travel of the mobile robot based on the obtained information about the distance to the charging station.

During the control of docking the mobile robot the charging station may be configured to: receive, through the plurality of station antennas, in response to a departure of the mobile robot from the charging station, the one or more first communication signals from the mobile robot, obtain the information about the distance between the charging station and the mobile robot and information about a direction from the charging station to the mobile robot based on the received one or more first communication signals, and set the information about the distance between the charging station and the mobile robot and the information about the direction from the mobile robot to the charging station as the position information of the charging station.

The plurality of robot antennas may be separated from one another by a distance less than or equal to a half wavelength of an ultra-wideband communication frequency.

The mobile robot may be further configured to: determine that communication with the plurality of beacons is not possible, and based on the determination may recognize current location information based on the one or more first communication signals.

The motion control system may further include: a sensor arranged in the mobile robot and configured to detect a motion of the mobile robot. The mobile robot may be configured to: determine whether communication with the plurality of beacons is possible, based on the determination that communication with the plurality of beacons is not possible: may control a 360-degree rotation of the mobile robot, and may correct sensing information detected by the sensor based on the received one or more first communication signals while controlling the 360-degree rotation of the mobile robot, and based on the determination that communication with the plurality of beacons is possible: may receive, through the plurality of robot antennas, the one or more second communication signals from the plurality of beacons, and may correct the sensing information detected by the sensor based on the received one or more first communication signals and the one or more second communication signals.

The mobile robot may further include: a motor fixed in the main body and having a driving axis; and at least one blade connected to the motor and rotatable about the driving axis. The motor may be configured to generate a driving power to rotate the at least one blade while the mobile robot travels.

### Advantageous Effects

According to embodiments of the disclosure, docking success rates of a mobile robot may increase by controlling the docking of the mobile robot using communication through a plurality of antennas arranged in a charging station and a plurality of antennas arranged in the mobile robot.

Specifically, aligning charging terminals of the charging station with charging terminals of the mobile robot during control of docking of the mobile robot may increase accuracy in docking between the charging station and the mobile robot and reduce the docking time.

According to the embodiments of the disclosure, as there is no need for a sensor for increasing accuracy in docking between the charging station and the mobile robot, manufacturing costs for the mobile robot may be reduced, and minimizing sensors to be equipped in the mobile robot may make it easy to manage the sensors of the mobile robot.

According to the embodiments of the disclosure, accuracy in information about a direction and angle of the mobile robot may increase by obtaining direction information of the mobile robot based on communication information from the charging station and a plurality of beacons and correcting sensing information detected by an inertia sensor based on the direction information of the mobile robot. Accordingly, docking control performance of the mobile robot may be improved.

According to embodiments of the disclosure, there is no need for installing a perimeter wire around a working area, thereby saving the time and cost for mowing.

### DESCRIPTION OF DRAWINGS

FIG. 1 illustrates a motion control system including a mobile robot, according to an embodiment.

FIG. 2 is a perspective view of a motion control system including a mobile robot, a charging station and beacons, according to an embodiment.

FIG. 3A is a cross-sectional view of a mobile robot, according to an embodiment, and FIG. 3B is a plan view of a mobile robot, according to an embodiment.

FIG. 4 is a schematic diagram of communications between a mobile robot, a charging station and beacons, according to an embodiment.

FIG. 5 illustrates recognition of location information of a mobile robot, according to an embodiment.

FIG. 6 illustrates a charging station communicating with a mobile robot, according to an embodiment.

FIG. 7 illustrates how to recognize information about a distance and direction to the charging station shown in FIG. 6.

FIG. 8 illustrates docking between the mobile robot and the charging station shown in FIG. 6.

FIGS. 9A and 9B illustrate a communication device in the charging station shown in FIG. 6.

FIG. 10 is a control block diagram of a mobile robot, according to an embodiment.

FIGS. 11A and 11B illustrate how to correct sensing information of a sixth sensor (inertia sensor) arranged in a mobile robot, according to an embodiment.

FIG. 12 illustrates docking of a mobile robot, according to an embodiment.

FIG. 13 illustrates a distance between a mobile robot and charging terminals of a charging station during docking of the mobile robot, according to an embodiment.

FIG. 14 illustrates how to recognize current location information of a mobile robot when communication of the mobile robot is not possible, according to an embodiment.

### MODES OF THE INVENTION

It is understood that various embodiments of the disclosure and associated terms are not intended to limit technical features herein to particular embodiments, but encompass various changes, equivalents, or substitutions.

Like reference numerals may be used for like or related elements throughout the drawings.

The singular form of a noun corresponding to an item may include one or more items unless the context states otherwise.

Throughout the specification, “A or B”, “at least one of A and B”, “at least one of A or B”, “A, B or C”, “at least one of A, B and C”, and “A, B, or C” may each include any one or all the possible combinations of A, B and C.

Terms like “first”, “second”, etc., may be simply used to distinguish an element from another, without limiting the elements in a certain sense (e.g., in terms of importance or order).

When an element is mentioned as being “coupled” or “connected” to another element with or without an adverb “functionally” or “operatively”, it means that the element may be connected to the other element directly (e.g., wiredly), wirelessly, or through a third element.

It will be further understood that the terms “comprise” and/or “comprising,” when used in this specification, specify the presence of stated features, integers, steps, operations, elements, parts or combinations thereof, but do not preclude the possible presence or addition of one or more other features, integers, steps, operations, elements, components, and/or groups thereof.

When an element is mentioned as being “connected to”, “coupled to”, “supported on” or “contacting” another element, it includes not only a case that the elements are directly connected to, coupled to, supported on or contact each other but also a case that the elements are connected to, coupled to, supported on or contact each other through a third element.

Throughout the specification, when an element is mentioned as being located “on” another element, it implies not only that the element is abut on the other element but also that a third element exists between the two elements.

The expression “and/or” is interpreted to include a combination or any of associated elements.

The principle and embodiments of the disclosure will now be described with reference to accompanying drawings.

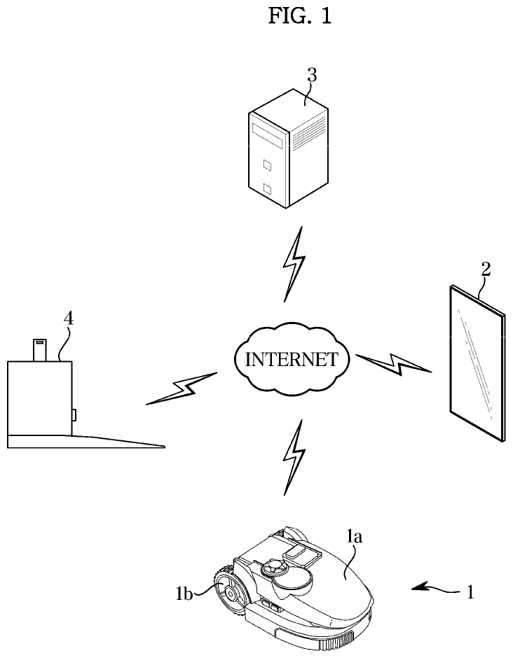

FIG. 1 illustrates a motion control system including a mobile robot, according to an embodiment of the disclosure:

A mobile robot 1 may include a communication module for communicating with a home appliance, a user equipment 2, a server 3 or a charging station 4, a user interface for receiving user inputs or outputting information for the user, at least one processor for controlling operation of the mobile robot 1, and at least one memory for storing a program for controlling the operation of the mobile robot 1.

The home appliance may be at least one of various kinds of home appliances. For example, the home appliance may include at least one of a refrigerator, a dish washer, an electric range, an electric oven, an air conditioner, a garment care system, a washing machine, a dryer, or a microwave oven as shown, but is not limited thereto. For example, the home appliance may include various types of home appliances such as a cleaning robot, a vacuum cleaner, a television, etc., not shown in the drawing.

The aforementioned home appliances are merely an example, and in addition to the aforementioned home appliances, any device connected to another home appliance, the user equipment 2 or the server 3 to perform operations as will be described below may belong to the home appliance according to an embodiment.

The server 3 may include a communication module for communicating with another server, the home appliance, the user equipment 2 or the charging station 4, at least one processor for processing data received from the other server, the home appliance 2, the user equipment 4 or the charging station 4, and at least one memory for storing a program for processing data or storing the processed data. The server 3 may be implemented with various computing devices such as a workstation, a cloud, a data drive, a data station, etc. The server 3 may be implemented with one or more servers physically or logically classified based on function, sub-configuration of the function or data, and may transmit or receive data through inter-server communication and process the data.

The server 3 may perform functions, such as managing a user account, registering the mobile robot 1 by connecting the mobile robot 1 to the user account, and managing or controlling the registered mobile robot 1. For example, the user may access the server 3 through the user equipment 2 to create a user account. The user account may be identified by an identity (ID) and a password created by the user. The server 3 may register the mobile robot 1 with the user account according to a set procedure. For example, the server 3 may connect identification information (e.g., a serial number, a media access control (MAC) address, etc.) of the mobile robot 1 to the user account to register, manage and control the mobile robot 1.

The user equipment 2 may include a communication module for communicating with the mobile robot 1, the home appliance, the server 3 or the charging station 4, a user interface for receiving user inputs or outputting information for the user, at least one processor for controlling operation of the user equipment 2, and at least one memory for storing a program for controlling the operation of the user equipment 2.

The user equipment 2 may be carried by the user or placed at the user's home or office. The user equipment 2 may include a personal computer, a terminal, a portable telephone, a smart phone, a handheld device, a wearable device, etc., without being limited thereto.

In the memory of the user equipment 2, a program for controlling the mobile robot 1, i.e., an application, may be stored. The application may be sold in a state of being installed in the user equipment 2, or may be downloaded from an external server to be installed.

The user may access the server 3 and create a user account by running the application installed in the user equipment 2, and register the mobile robot 1 and the home appliance by communicating with the server 3 based on the login user account.

For example, when the mobile robot 1 is operated to access the server 3 according to a procedure guided in the application installed in the user equipment 2, the server 3 may register the mobile robot 1 with the user account by registering the identification information (e.g., a serial number or a MAC address) of the mobile robot 1 with the user account.

The user may use an application installed in the user equipment 2 to control the mobile robot 1. For example, when the user logs in on the user account with the application installed in the user equipment 2, the mobile robot 1 registered with the user account may appear thereon, and when a control command is input for the mobile robot 1, the control command may be forwarded to the mobile robot 1 through the server 3.

A network may include both a wired network and a wireless network. The wired network may include a cable network or a telephone network, and the wireless network may include any network that transmits or receives signals in radio waves. The wired network and the wireless network may be connected to each other.

The network may include a wide area network (WAN) such as the Internet, a local area network (LAN) formed around an access point (AP), a short-range wireless network without an AP. The short-range wireless network may include bluetooth (IEEE 802.15.1), Zigbee (IEEE 802.15.4), wireless fidelity (Wi-Fi) direct, near field communication (NFC), Z-wave, etc., without being limited thereto.

The AP may connect the mobile robot 1, the home appliance, the user equipment 2 or the charging station 4 to the WAN connected to the server 3. The mobile robot 1, the home appliance, the user equipment 2 or the charging station 4 may be connected to the server 3 through the WAN.

The AP may use wireless communication such as Wi-Fi (IEEE 802.11), Bluetooth (IEEE 802.15.1), Zigbee (IEEE 802.15.4), etc., to communicate with the mobile robot 1, the home appliance, the user equipment 2 or the charging station 4, and use wired communication to access the WAN, but is not limited thereto.

In various embodiments, the mobile robot 1 may be directly connected to the user equipment 2, the server 3 or the charging station 4 without using the AP.

The mobile robot 1 may be connected to the user equipment 2, the server 3 or the charging station 4 over a long-range wireless network or a short-range wireless network.

For example, the mobile robot 1 may be connected to the user equipment 2 over a short-range wireless network (e.g., Wi-Fi direct).

In another example, the mobile robot 1 may use the long-range wireless network (e.g., a cellular communication module) to be connected to the user equipment 2, the server 3 or the charging station 4 over the WAN.

In another example, the mobile robot 1 may connect to the WAN by using wired communication, and connect to the user equipment 2, the server 3 or the charging station 4 over the WAN.

When the mobile robot 1 is able to access the WAN through the wired communication, the mobile robot 1 may operate as an AP. Accordingly, the mobile robot 1 may connect the home appliance to the WAN to which the server 3 is connected. Furthermore, the home appliance may connect the mobile robot 1 to the WAN to which the server 3 is connected.

The mobile robot 1 may transmit information about the operation or status to the home appliance, the user equipment 2, the server 3 or the charging station 4 over the network. For example, on receiving a request from the server 3 or when a particular event occurs in the mobile robot 1, the mobile robot 1 may transmit the information about the operation or the status to the home appliance, the user equipment 2, the server 3 or the charging station 4 periodically or in real time. On receiving the information about the operation or status from the mobile robot 1, the server 3 may update information about the operation or status of the mobile robot 1 that has been stored, and transmit the updated information about the operation and status of the mobile robot 1 to the user equipment 2 over the network. The updating of the information may include various operations to change the existing information such as adding new information to the existing information, replacing the existing information with the new information, etc.

The mobile robot 1 may obtain various information from the home appliance, the user equipment 2, the server 3 or the charging station 4, and provide the obtained information to the user. For example, the mobile robot 1 may obtain information about a function of the mobile robot 1 or various environmental information (e.g., weather, temperature, humidity, etc.) from the server 3 and output the obtained information through the user interface.

The mobile robot 1 may operate according to a control command received from the home appliance, the user equipment 2, the server 3 or the charging station 4. For example, when the mobile robot 1 has won prior approval of the user to operate according to a control command of the server 3 even without a user input, the mobile robot 1 may operate according to the control command received from the server 3. The control command received from the server 3 may include a control command input by the user through the user equipment 2, a control command based on a preset condition or the like, without being limited thereto.

The user equipment 2 may transmit information about the user to the mobile robot 1, the home appliance, the server 3 or the charging station 4 through the communication module. For example, the user equipment 2 may transmit information about a location of the user, a physical condition of the user, a preference of the user, a schedule of the user, etc., to the server 3. The user equipment 2 may transmit the information about the user to the server 3 according to prior approval of the user.

The mobile robot 1, the home appliance, the user equipment 2, the server 3 or the charging station 4 may determine a control command by using a technology such as artificial intelligence (AI). For example, the server 3 may receive information about the operation or status of the mobile robot 1 or information about the user of the user equipment 2, process the information by using a technology such as AI, and transmit a result of the processing or a control command to the mobile robot 1 or the user equipment 2 based on the result of the processing.

In an embodiment of the disclosure, the mobile robot 1 may correspond to any robot that is able to travel autonomously. The mobile robot 1 as will be described below is assumed to be a robot for cutting the grass as an example.

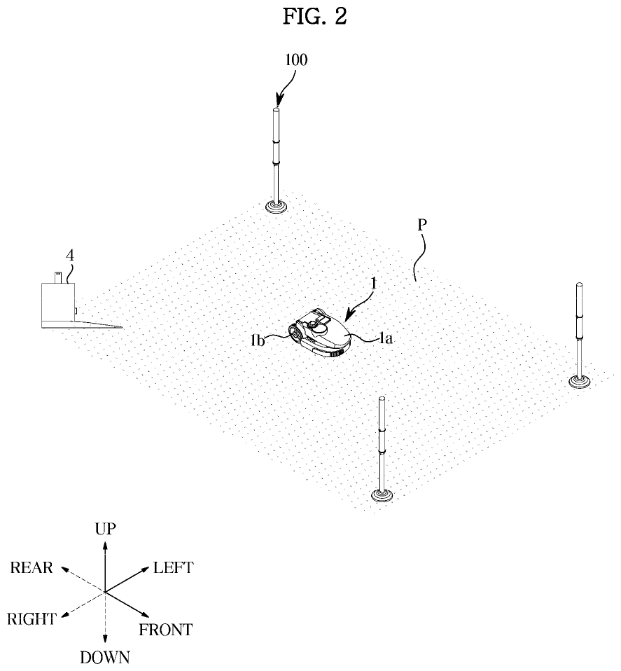

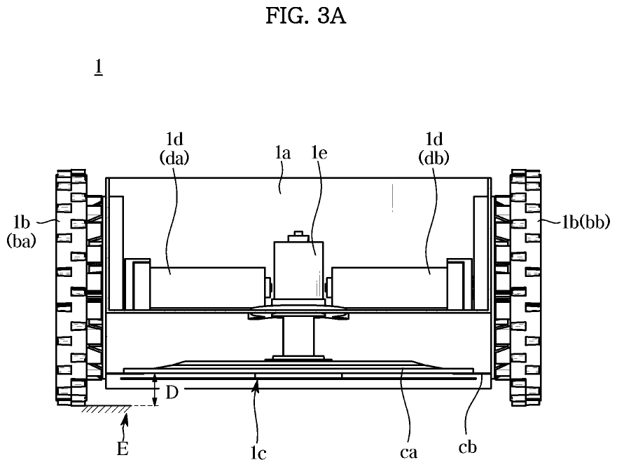

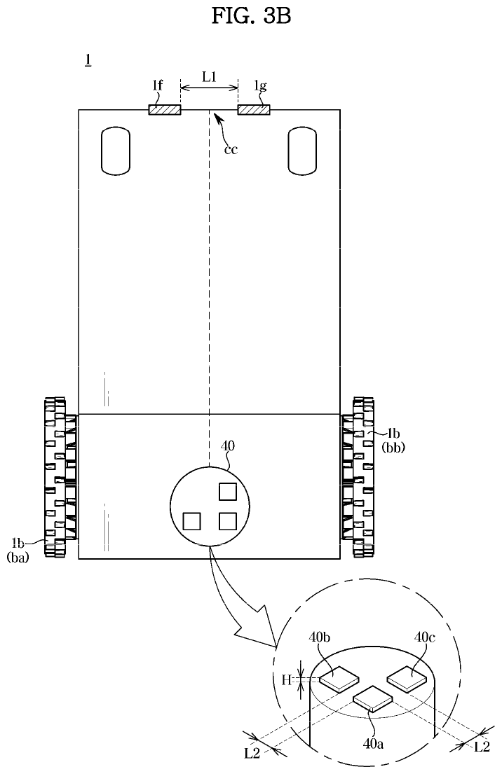

FIG. 2 is a perspective view of a motion control system including a mobile robot, a charging station and beacons, according to an embodiment, FIG. 3A is a cross-sectional view of the mobile robot, according to an embodiment, and FIG. 3B is a plan view of the mobile robot, according to an embodiment.

As shown in FIGS. 2, 3A and 3B, the mobile robot 1 may include a main body 1a that defines the exterior, a plurality of wheels 1b arranged on a lower portion of the main body 1a to be rotatable on an axis that is parallel to the ground to move the main body 1a, and a blade 1c that is a cutting member arranged underneath the main body 1a to be rotatable on an axis perpendicular to the ground to cut the grass.

The mobile robot 1 may further include a first motor 1d for applying rotational power to the plurality of wheels 1b and a second motor 1e for applying rotational power to the blade 1c.

The terms “forward (or front)”, “upward (or up)”, “downward (or down)”, “left” and “right” as herein used are defined with respect to a direction in which the mobile robot moves forward, but the terms may not restrict the shapes and positions of the respective components.

The expressions, as will be mentioned, indicating directions such as “front F/rear R/left Le/right Ri/up U/down D are defined according to what are shown in the drawings, which are for describing the disclosure to be clearly understood in all respects and may obviously be defined otherwise according to defined criteria.

The mobile robot 1 may travel a patch of grass. The patch of grass may be called a working area P of the mobile robot 1.

A housing of the main body 1a may form the exterior of the mobile robot 1.

The plurality of wheels 1b may be arranged on the sides of the housing of the main body 1a to be rotatable. The plurality of wheels 1b may be arranged on both sides of the housing of the main body 1a. The plurality of wheels 1b may include a plurality of projections.

Each of the plurality of wheels 1b may be connected to the first motor 1d arranged in the housing of the main body 1a.

There may be a number of first motors 1d corresponding to the number of the wheels. In other words, there may be a plurality of first motors 1d to match the plurality of wheels 1b.

The plurality of first motors 1d may be controlled at different rotation velocities.

The plurality of first motors 1d may provide driving power for the mobile robot 1 to travel while being controlled by the processor 50 at different numbers of revolutions, and a moving direction of the mobile robot may be changed by a difference between rotation velocities of the wheels 1b.

The blade 1c may be connected to the second motor 1e arranged in the housing of the main body 1a.

The second motor 1e may be arranged in a lower surface of the housing of the main body. The second motor 1e may be fixed to the housing and may generate driving power to rotate the blade 1c.

The blade 1c may be formed in the shape of a round plate, and may include a rotation plate connected to a driving axis of the second motor 1e and a plurality of blades arranged at the edges of the rotation plate at regular intervals.

The blade 1c may move up and down along the height of the main body 1a.

The blade 1c may be separated from the earth E or ground by a set distance. The set distance is a distance according to a user command, which may be a distance corresponding to the height of the blade 1c.

The mobile robot may control the height at which to cut the grass according to the height of the blade 1c.

As shown in FIG. 3B, the mobile robot 1 includes first and second charging terminals 1f and 1g arranged on the front of the main body 1a and connected to a battery 80 to supply power to charge the battery 80.

The first and second charging terminals 1f and 1g may be arranged at a first distance L1 from each other.

The first and second charging terminals 1f and 1g may be electrically and mechanically connected to third and fourth charging terminals arranged on the charging station 4 while the mobile robot is docked at the charging station.

The mobile robot 1 may include a communicator 40 arranged to protrude from the upper surface of the main body 1a. The communicator 40 of the mobile robot 1 may communicate with the charging station 4 and the plurality of beacons 100.

The communicator 40 may be arranged in an area between the first and second charging terminals 1f and 1g at a middle location CC between the first and second charging terminals 1f and 1g.

The communicator 40 may include a plurality of antennas 40a, 40b and 40c. The plurality of antennas may be provided in two, three or more.

The plurality of antennas 40a, 40b and 40c may be arranged at the middle location CC between the first and second charging terminals 1f and 1g.

The plurality of antennas 40a, 40b and 40c may be arranged on the same level of the upper surface, which may be the top surface of the main body 1a.

The plurality of antennas 40a, 40b and 40c may be arranged on the upper surface of the main body 1a to protrude equally as far as height H.

The second robot antenna 40b is arranged on a first side of the first robot antenna 40a and spaced apart from the first robot antenna 40a at a second distance L2.

The second distance L2 may correspond to a half or less of a wavelength of the ultra-wideband communication frequency.

An extractable range of the ultra-wideband communication frequency is ±90 degrees, so the second distance L2 may be set as a distance corresponding to the half or less of the wavelength of the ultra-wideband communication frequency.

A line connecting the first and second robot antennas 40a and 40b may be perpendicular to a movement line for forward motion of the mobile robot. In other words, the first and second robot antennas 40a and 40b separately arranged in line at the second distance apart may be perpendicular to a forward movement direction of the mobile robot.

The third robot antenna 40c is arranged on a second side of the first robot antenna 40a and spaced apart from the first robot antenna 40a at a second distance L2.

The second side of the first robot antenna 40a may be perpendicular to the first side of the first robot antenna 40a.

A line connecting the first and third robot antennas 40a and 40c may be parallel to the movement line for forward motion of the mobile robot.

In other words, the first and third robot antennas 40a and 40c arranged in line and spaced the second distance apart may be parallel to the forward movement direction of the mobile robot.

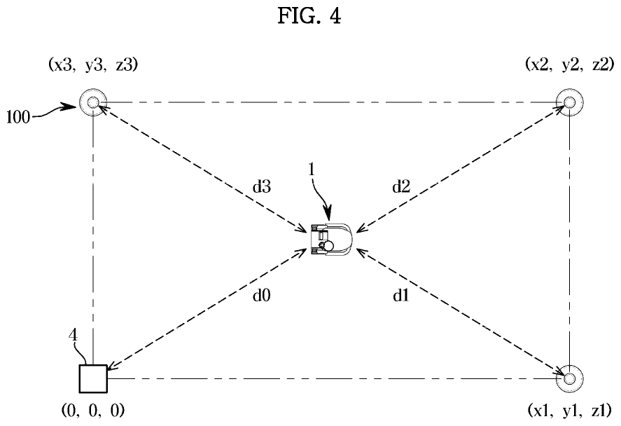

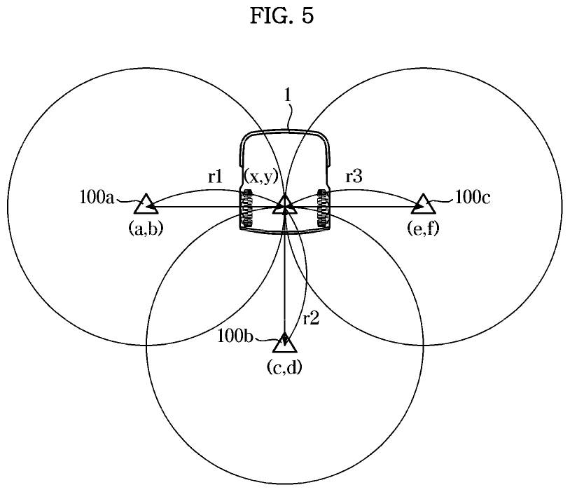

FIG. 4 is a schematic diagram of communications between the mobile robot 1, the charging station 4 and the beacons 100, according to an embodiment, and FIG. 5 illustrates recognition of location information of the mobile robot, according to an embodiment.

The beacons 100 and the charging station 4 may be placed in a boundary area of the working area P. In the embodiment, the working area may be formed by the plurality of beacons 100 and the charging station 4 into a polygonal shape.

For example, the working area P may be formed by three beacons and the charging station 4 into a rectangle, and by four beacons and the charging station 4 into a pentagon. As such, the working area may have various shapes, and the shape of the working area may vary depending on the number of beacons.

The mobile robot 1 may communicate with the plurality of beacons 100 and the charging station 4. The mobile robot 1 may receive a signal from at least one of the plurality of beacons 100, transmit a signal to at least one of the plurality of beacons 100, receive a signal from the charging station 4, and transmit a signal to the charging station 4.

The signal received by the mobile robot 1 from the at least one beacon 100 may be un ultra-wideband (UWB) communication signal, and the signal transmitted by the at least one beacon 100 to the mobile robot 1 may include information about a location of the at least one beacon 100.

The signal received by the mobile robot 1 from the charging station 4 may be a UWB communication signal. The signal transmitted by the charging station 4 to the mobile robot 1 may include information about a location of the charging station 4.

The plurality of beacons 100 may communicate with each other and also communicate with the charging station 4. In this case, each of the beacons 100 and the charging station 4 may mutually measure a relative coordinate system and then measure a UWB communication distance to the mobile robot 1. Each of the beacons 100 and the charging station 4 may measure a location of the mobile robot 1 in the measured relative coordinate system by triangulation.

The mobile robot 1 may measure a direction and distance of a signal triggered by each of the beacons 100 located at a plurality of fixed points, and recognize location information of the mobile robot 1 in the working area P based on the measured direction and distance of the signal.

The mobile robot 1 may measure a direction and distance of a signal triggered by the charging station 4, and recognize location information of the mobile robot 1 in the working area P based on the measured direction and distance of the signal.

Furthermore, the mobile robot 1 may recognize the current location of the mobile robot 1 by using the principle of global positioning system (GPS) with information about a location of the charging station received from the charging station 4 and information about locations of two or more beacons 100 received from the beacons 100.

Referring to FIG. 4, the mobile robot 1 may receive signals from the charging station 4 and the beacons 100 installed in the working area P.

The charging station 4 and the beacons 100 transmit signals to generate a location coordinate system of the mobile robot 1. The charging station 4 and the beacons 100 may support UWB communication of the mobile robot 1.

For example, the beacon 100 may include a UWB antenna and a printed board assembly (PBA) connected to the UWB antenna and including at least one device to control the beacon 100. The PBA may include a power circuit that receives power from a battery (not shown) and supplies the power to the beacon 100.

The PBA may further include a function of bluetooth communication (BLU). In this case, the PBA may further include a BLE antenna.

The beacon 100 may further include a cable for connecting the UWB antenna to at least one device of the PBA. The cable may deliver radio frequency (RF) transmission or reception signals between the UWB antenna and the PBA. The cable may include a coaxial cable.

On receiving signals from the charging station 4 and signals from the two or more beacons 100, the mobile robot 1 may recognize the current location of the mobile robot 1 based on the information about a location of the charging station 4 and the information about locations of the beacons 100 stored in advance. The information about the location of the charging station 4 and

information about the locations of the beacons 100 stored in advance are about coordinates of the locations, which may be input by the user. The mobile robot 1 may recognize coordinates of the location of the mobile robot 1.

On receiving signals from three or more beacons 100, the mobile robot 1 may recognize the current location of the mobile robot 1 based on the information about locations of the beacons 100 stored in advance.

Referring to FIG. 5, the mobile robot 1 may store information about coordinates of locations of a first beacon 100a to third beacon 100c, and when receiving signals from the first beacon 100a, the second beacon 100b and the third beacon 100c, recognize coordinates of a location of the mobile robot 1 by triangulation between the first beacon 100a, the second beacon 100b and the third beacon 100c and the mobile robot 1.

As shown in FIG. 5, assuming that coordinates of the location of the mobile robot 1 is (x, y), coordinates of the location of the first beacon 100a is (a, b), coordinates of the location of the second beacon 100b is (c, d), and coordinates of the location of the third beacon 100c is (e, f), and distances from the mobile robot 1 to the respective first to third beacons 100a, 100b and 100c are r1 to r3, the mobile robot 1 may recognize the coordinates of the location (x, y) of the mobile robot 1 according to equations 1, 2 and 3.

The coordinates of the location (x, y) of the mobile robot 1 may be coordinates of a location of the communicator equipped in the mobile robot.

$${( x - a )}^{2} + {( y - b )}^{2} = r {1}^{2} \qquad [ Equation 1 ]$$

$${( x - c )}^{2} + {( y - d )}^{2} = r {2}^{2} \qquad [ Equation 2 ]$$

$${( x - e )}^{2} + {( y - f )}^{2} = r {3}^{2} \qquad [ Equation 3 ]$$

In this case, procedures for obtaining the distances r1, r2 and r3 from the mobile robot 1 to the first, second and third beacons 100a, 100b and 100c may be the same. Hence, the procedure for obtaining the distance r1 between the first beacon 100a and the mobile robot 1 will be described.

The first beacon 100a transmits UWB pulses with preset intensity (voltage) to the mobile robot 1. In this case, the mobile robot 1 may receive a bit distorted signal from the UWB pulses after the lapse of certain time T, determine a time at which the signal is received, and obtain the distance r1 between the mobile robot 1 and the first beacon 100a by multiplying the determined time by velocity of radio waves, e.g., 300,000 km/s.

The mobile robot 1 and the first beacon 100a have synchronized timers.

The signal used to determine a distance between the first beacon 100a and the mobile robot 1 may include an infrared signal, an RF signal, a bluetooth signal, etc., in addition to the UWB signal, but is not limited thereto.

When the coordinates of the current location of the mobile robot 1 are recognized, the mobile robot 1 may control autonomous traveling based on the recognized coordinates of the current location. In other words, the mobile robot 1 may travel based on the beacons 100 arranged in the working area as shown in FIG. 1.

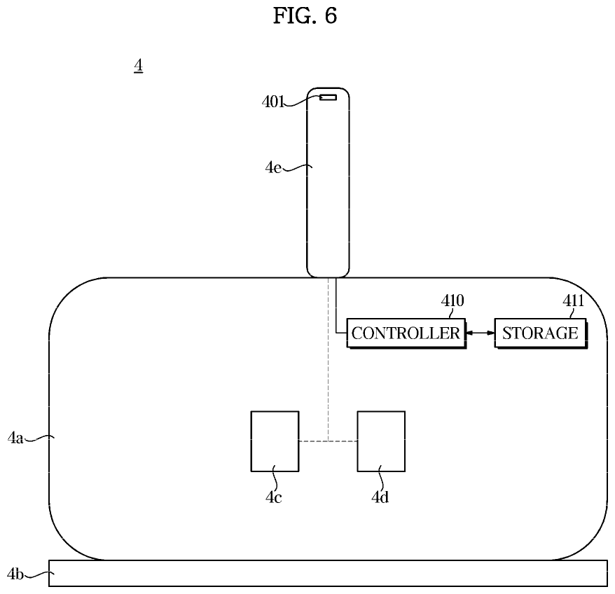

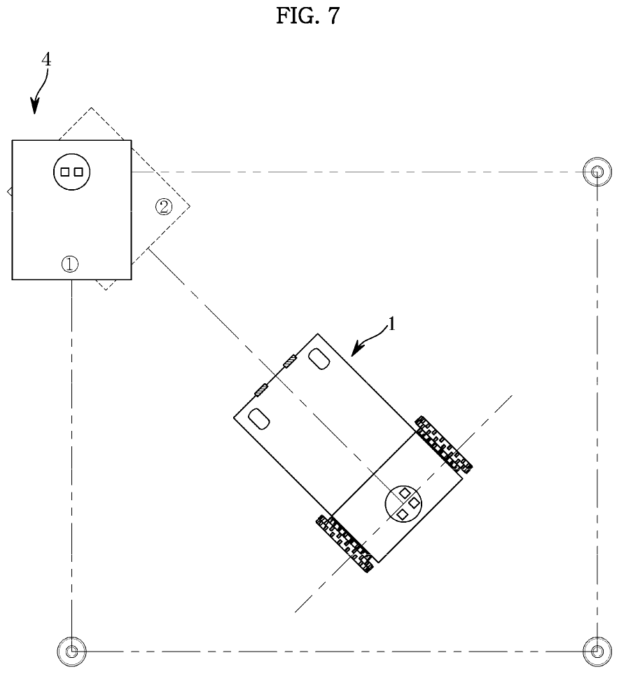

FIG. 6 illustrates a charging station at which the mobile robot is docked, according to an embodiment, which will be described in connection with FIGS. 7, 8, 9A and 9B.

The charging station 4 may supply power to charge the battery 80 equipped in the mobile robot 1. The charging station 4 may be connected to a commercial power source, receive power from the commercial power source, perform power transformation on the supplied power and provide the transformed power to the mobile robot 1. The charging station 4 may transform the commercial power to power for charging the battery 80 of the mobile robot 1.

The charging station 4 may transmit, to the mobile robot 1 and the plurality of beacons 100, a signal to set up a boundary of the working area, and transmit, to the mobile robot 1, a signal to dock the mobile robot 1.

It is also possible that the charging station 4 receives signals from the mobile robot 1 and the plurality of beacons 100.

The charging station 4 may perform UWB communication with the mobile robot 1 and the plurality of beacons 100.

The charging station 4 may obtain information about a distance to the mobile robot 1, information about a direction to the mobile robot 1, information about distances to the plurality of beacons 100 and information about directions to the plurality of beacons 100 based on the signals received from the mobile robot 1 and the plurality of beacons 100. In this case, the charging station 4 may obtain information about a relative distance and relative direction to the mobile robot 1.

The charging station 4 may transmit the information about the distance and direction to the mobile robot 1 to the mobile robot 1. The information about the direction to the mobile robot 1 may include information about a relative angle with the mobile robot 1.

The information about the distance and direction to the mobile robot 1 may be information about a position of the charging station 4.

The charging station 4 may include a controller 410 and a storage 411.

The controller 410 controls general operation of the charging station 4. The controller 410 of the charging station may include one, two or more processors.

The controller 410 uses data stored in the storage 411 to control operations of the charging station 4.

The controller 410 may control docking and charging the mobile robot 1 and setting up the boundary of the working area.

The controller 410 may process communication signals of a communication device 4e.

The controller 410 may use a range measurement technology such as a time of flight (ToF) technology to obtain information about distances to the mobile robot 1 and the respective beacons 100.

Specifically, the controller 410 transmits a response signal to the mobile robot 1 and the plurality of beacons 100 in response to reception of a first impulse signal through an antenna 401 of the communication device 4e of the charging station. In this case, the mobile robot 1 and the plurality of beacons 100 may transmit, to the charging station 4, a second impulse signal which is a UWB signal in response to the response signal. The second impulse signal may include information about a delay time calculated based on information about a time at which the response signal is received and a time when the second impulse signal is transmitted.

The controller 410 may obtain information about distances to the mobile robot 1 and the respective beacons 100 based on information about a time when the response signal is transmitted, information about a time when the second impulse signal is received and information about the delay time included in the second impulse signal.

$$distance = ( t 2 - t 1 - t reply ) / 2 \qquad [ Equation 4 ]$$

where t2 is the time when the second impulse signal is received, t1 is the time when the response signal is transmitted, treply is the delay time, and c is a constant value indicating the speed of light.

It is also possible that the controller 410 obtains information about a distance between the charging station 4 and the mobile robot 1 based on a time difference between signals transmitted and received between the charging station 4 and the mobile robot 1 and obtains information about a distance between the charging station 4 and each beacon 100 based on a time difference between signals transmitted and received between the charging station 4 and the beacon 100.

The controller 410 may use an angle of arrival (AoA) positioning technology to obtain information about a distance and direction to the mobile robot 1 and obtain information about a distance and direction to each beacon 100.

When a UWB signal is transmitted from an antenna equipped in the mobile robot 1, the UWB signal may be received through two station antennas equipped in the charging station. In this case, there is a difference p in distance between the UWB signals entering the plurality of antennas equipped in the charging station.

An angle formed between a first line segment connecting the two station antennas equipped in the charging station 4 and an orthogonal second line segment is θ.

$$p = d sin θ \qquad [ Equation 5 ]$$

$$Sin θ = p / d \qquad [ Equation 6 ]$$

The controller 410 may control a signal to be transmitted or received multiple times to or from the mobile robot 1, share the information about transmission or reception time of the signal to eliminate time errors, and obtain information about a distance between one antenna equipped in the charging station 4 and the communicator of the mobile robot 1 based on time information obtained by elimination of the time errors.

The controller 410 may obtain information about a relative location of the mobile robot 1 based on the two station antennas equipped in the charging station 4 based on the information about the distance and the angle information θ between one station antenna equipped in the charging station 4 and the communicator 40 of the mobile robot 1.

$$A / 2 π = p / λ , θ = sin - 1 \times α λ / 2 πd$$

where α is a phase difference between received UWB signals.

As shown in FIG. 7, the controller 410 may obtain information about a relative distance and a relative direction to the charging station 4 based on the mobile robot 1. The information about the relative direction may include information about a relative angle of the charging station 4 based on the mobile robot 1.

The controller 410 may control transmission of the information about the relative distance and relative direction to the charging station 4.

That is, the controller 410 may transmit, to the mobile robot 1, the information about the relative distance and relative direction to the charging station 4.

The controller 410 may transmit, to the mobile robot 1, the information about the relative distance and relative angle of the charging station 4 as information about a position of the charging station 4 at the time of departure of the mobile robot.

The charging station 4 includes a main body 4a, a support 4b for supporting the main body 4a, the third and fourth charging terminals 4c and 4d arranged in the main body 4a and electrically and mechanically connected to the first and second charging terminals 1f and 1g of the mobile robot, and the communication device 4e for communicating with the mobile robot 1 and the plurality of beacons 100.

The third and fourth charging terminals 4c and 4d may be connected to a commercial power source, receive power from the commercial power source, and deliver the supplied power to the mobile robot 1.

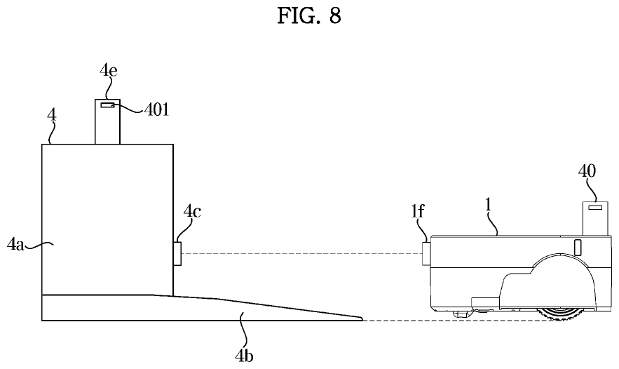

As shown in FIG. 8, the third and fourth charging terminals 4c and 4d may come into contact with the first and second charging terminals 1f and 1g of the mobile robot and deliver the commercial power to the mobile robot 1 through the first and second charging terminals 1f and 1g.

The third and fourth charging terminals 4c and 4d may be arranged to be separated by the first distance L1.

The communication device 4e may be arranged in an area between the third and fourth charging terminals 4c and 4d at a middle location CC between the third and fourth charging terminals 4c and 4d.

The communication device 4e may include a plurality of antennas 401. The plurality of antennas may be provided in two or more.

The plurality of antennas 401 may be arranged on the main body 4a of the charging station at the middle location CC between the third and fourth charging terminals 4c and 4d. The plurality of antennas 401 may be arranged on the main body 4a of the charging station in an extended line of the middle location CC between the third and fourth charging terminals 4c and 4d.

As shown in FIG. 8, the plurality of antennas 401 may be located on the upper surface of the main body 4a of the charging station at the same top level.

The plurality of antennas 401 may be arranged on the upper surface of the main body 4a to protrude equally as far as height.

The plurality of antennas 401 may be UWB communication antennas.

When there are two antennas arranged on the charging station 4, the two antennas may be arranged at the second distance from each other. The second distance L2 may correspond to a half or less of a wavelength of the UWB communication frequency.

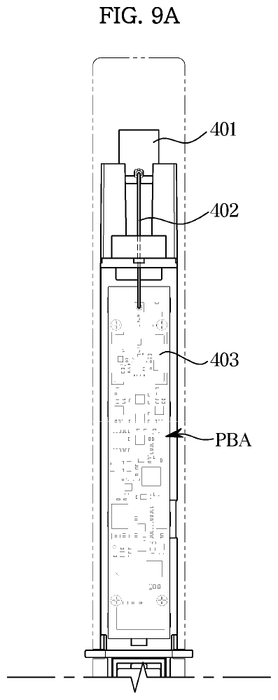

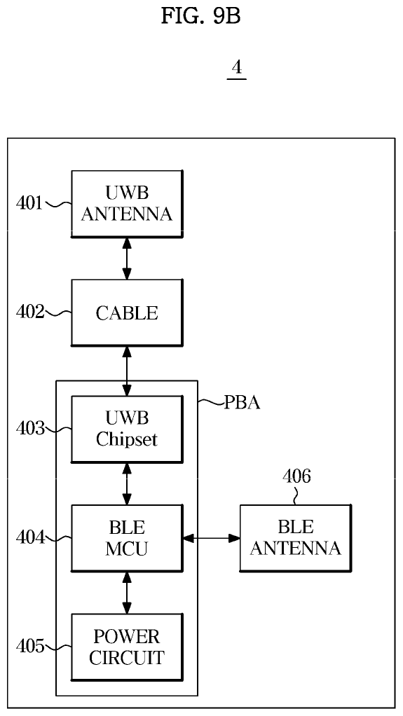

A structure of the communication device 4e of the charging station will be described in connection with FIGS. 9A and 9B.

The communication device 4e may include an antenna 401. There may be two or more antennas 401.

The antenna 401 may include a UWB communication antenna for transmitting and receiving UWB communication radio waves. The UWB communication antenna 401 may include an antenna having omni-directional radiation characteristics for securing uniform communication ranges in all directions.

The antenna 401 may be formed in the shape of a rectangular plate. A cable 402 may be connected to a lower center of the antenna 401.

The communication device 4e may include the cable 402 for connecting the antenna 401 to a PBA. The cable 402 may deliver RF transmission and reception signals between the antenna 401 and the PBA. The cable 402 may include a coaxial cable.

The cable 402 of the charging station may connect between the antenna 401 and a UWB chipset 403 on the PBA.

The communication device 4e may be connected to the antenna and may include the PBA including at least one controller for controlling the charging station 4.

The PBA may include the UWB chipset 403 arranged to perform a UWB RF communication function, and a bluetooth microcomputer (BLE MCU) 404 arranged to perform a bluetooth (BLE) communication function.

The UWB chipset 403 on the PBA may perform the UWB RF communication function.

The BLE MCU 404 may control setup of the UWB communication and operation of the charging station 4.

The PBA may further include a power circuit 405 for controlling power of the communication device.

The PBA may further include a wireless communication function other than the UWB chipset 403, e.g., a BLE or Wi-Fi communication function. The PBA may further include a BLE antenna 406 arranged to perform a BLE communication function.

The PBA may share the antenna 401 for communication of the BLE MCU 404.

At least one component may be added to or omitted to correspond to the performance of the components of the charging station 4 as shown in FIG. 6. Furthermore, it will be obvious to those of ordinary skill in the art that the relative positions of the components may be changed to correspond to the performance or structure of the charging station 4.

The components shown in FIG. 6 may refer to software, or hardware components such as Field Programmable Gate Arrays (FPGAs) and Application Specific Integrated Circuits (ASICs).

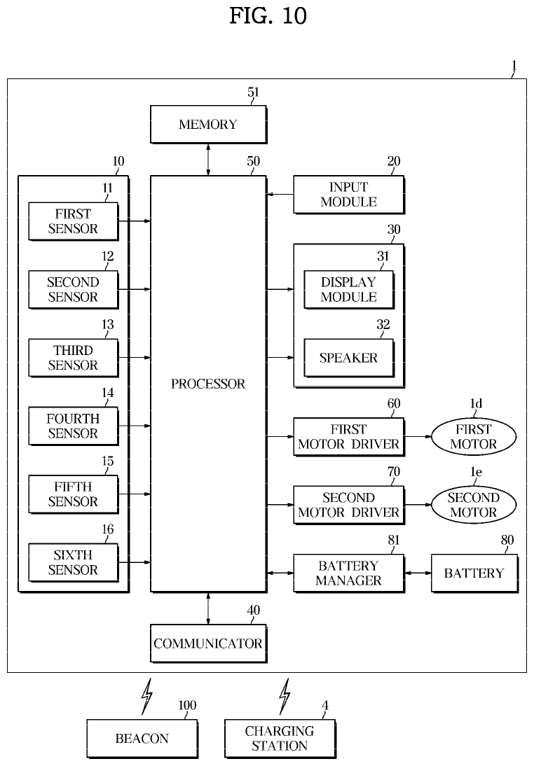

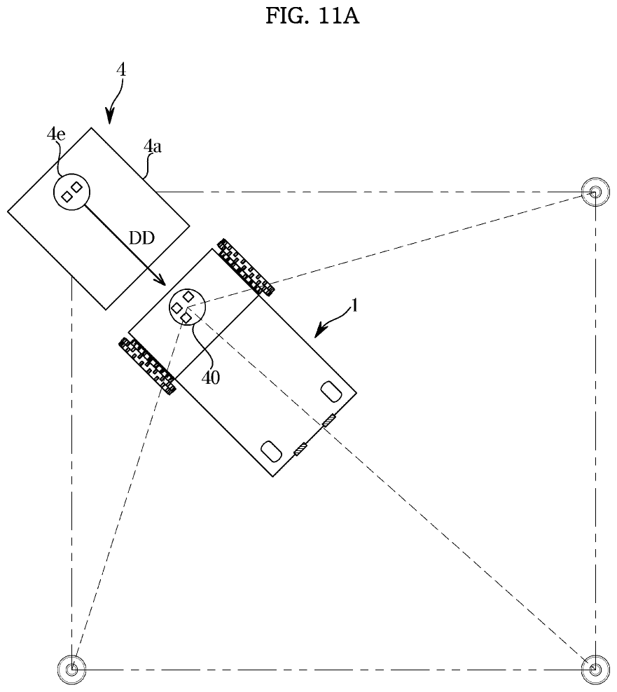

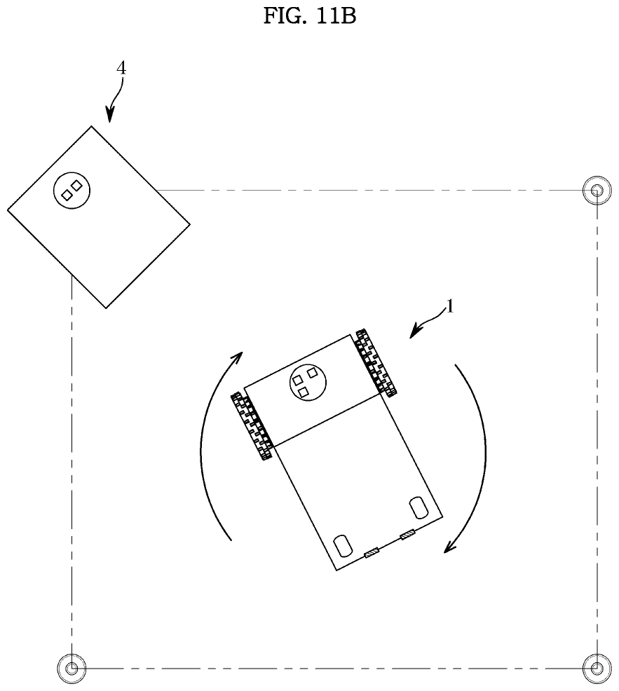

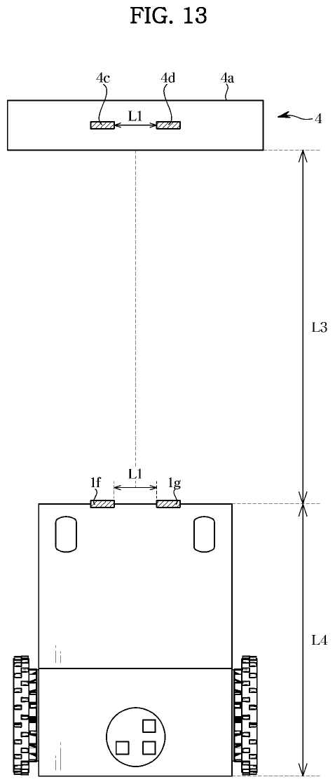

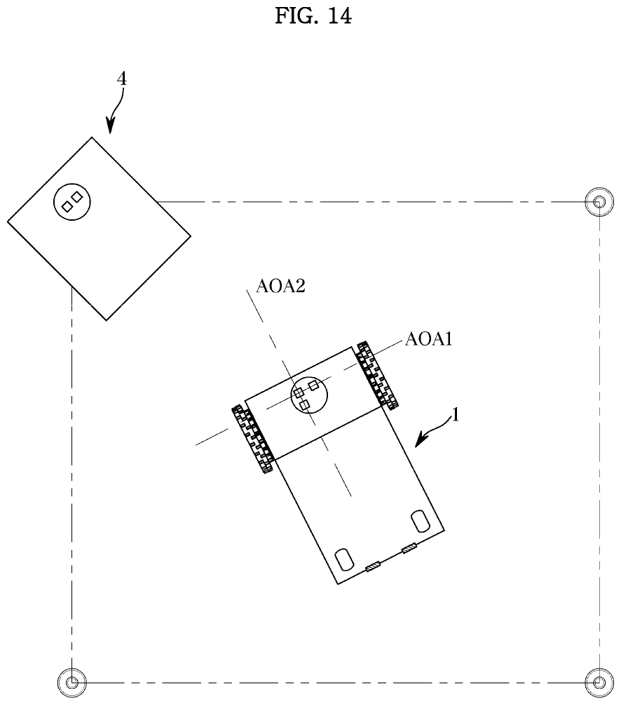

FIG. 10 is a control block diagram of a mobile robot, according to an embodiment, which will be described in connection with FIGS. 11A, 11B, 12, 13 and 14.

As shown in FIG. 10, the mobile robot 1 may include a sensor module 10, an input module 20, an output module 30, the communicator 40, the processor 50 and a memory 51, and further include a first motor driver 60 and a second motor driver 70, and further include the battery 80 and a battery manager 81.

The sensor module 10 may detect environmental information of the working area.

The environmental information of the working area may include information about an obstacle in a working environment and boundary information of the working area.

The obstacle information may include information about a location of the obstacle and information about height of the obstacle. The information about the location of the obstacle may include information about a relative direction and a relative distance to the mobile robot 1. The height information of the obstacle may include information about height from the ground of the working area. The height information of the obstacle may also include information about depth of the depressed ground.

The sensor module 10 may include a first sensor 11 for detecting the obstacle information.

There may be one, two or more first sensors 11.

The first sensor 11 may include one, two or more light detection and ranging (Lidar) sensors. The Lidar sensor is a non-contact distance detection sensor that uses a laser radar principle. The Lidar sensor has higher accuracy in lateral detection as compared to a radio detecting and ranging (radar) sensor.

The first sensor 11 may correspond to one, two or more radar sensors. The radar sensor is to detect a position and distance of an object by means of reflective waves generated by radiation of radio waves when transmission and reception are performed at the same spot.

The first sensor 11 may include one, two or more ultrasonic sensors. The ultrasonic sensor generates ultrasonic waves for a certain time and then detects a signal reflecting and returning from the object. The ultrasonic sensor may be used to distinguish whether there is an obstacle in a short range.

The sensor module may include a second sensor 12 for obtaining image information of a surrounding environment of the mobile robot 1.

The second sensor 12 may include one, two or more image sensors. The image information of the surrounding environment of the mobile robot 1 may include image information of a front environment of the mobile robot.

The image sensor may include a plurality of photo diodes for converting light into an electric signal, and the plurality of photo diodes may be arranged in a two-dimensional (2D) matrix.

The image sensor may include a charge-coupled device (CCD) or complementary metal-oxide semiconductor (CMOS) image sensor, and also include three-dimensional (3D) spatial recognition sensor such as KINECT (an RGB-D sensor), time of flight (TOF) (a structured light sensor), a stereo camera, etc.

The image sensor may include a camera.

The mobile robot 1 may use an image obtained by the camera to separately recognize inside and outside of the working area and recognize an obstacle in the working area. The mobile robot 1 may use the image obtained by the camera to recognize the shape, color, position, etc., of the obstacle.

The mobile robot 1 may use the image obtained by the camera to recognize images of the beacons 100, and may also recognize boundary information of the working area based on the recognized images of the beacons 100 and recognize current location information of the mobile robot 1 in the working area.

The sensor module 10 may detect status information of the mobile robot 1 and traveling information of the mobile robot 1.

For example, the status information of the mobile robot 1 may include state-of-charge (SoC) information of the battery and error information. The traveling information of the mobile robot 1 may include traveling speed information and traveling direction information.

The sensor module 10 may include a third sensor 13 for detecting the SoC information of the battery 80.

There may be one, two or more third sensors 13.

The third sensor 13 may include a voltage sensor for detecting a voltage across both terminals of the battery, and further include a current sensor for detecting a current flowing to the battery and a temperature sensor for detecting a temperature of the battery.

The sensor module 10 may include a fourth sensor 14 for detecting traveling information of the mobile robot. The fourth sensor 14 may be connected to the first motor 1d to detect rotation speed of the first motor 1d.

There may be one, two or more fourth sensors 14. The number of the fourth sensors 14 may be equal to the number of the first motors 1d. In other words, a plurality of first rotation speed sensors may be connected to the plurality of first motors 1d to detect rotation speeds of the plurality of first motors 1d, respectively.

The sensor module 10 may include a fifth sensor 15 for detecting rotation speed of the blade 1c. In this case, the fifth sensor 15 may be connected to the second motor 1e to detect rotation speed of the second motor 1e.

The sensor module 10 may further include a sixth sensor 16 for detecting a change in motion of the mobile robot 1.

The sixth sensor 16 may be a sensor for detecting inertial force of the motion of the mobile robot such as acceleration, velocity, direction and distance of the mobile robot, and may include an inertia sensor (or inertial measurement unit (IMU)).

The sixth sensor 16 may also include one of a gyro sensor, an acceleration sensor and a geomagnetic sensor. The gyro sensor and the acceleration sensor may be implemented by tri-axis, six-axis or nine-axis gyro sensor and acceleration sensor.

The input module 20 may receive a user input.

For example, the user input may include a command to start work, a command to pause, a command to stop work and a charge command.

The input module 20 may include hardware devices such as many different buttons or switches, a pedal, a keyboard, a mouse, a track ball, various levers, a handle, a stick, or the like.

Alternatively, the input module 20 may include a graphical user interface (GUI) such as a touch pad, i.e., a software device. The touch pad may be implemented with a touch screen panel (TSP), thus forming an interlayer structure with a display module.

The display module may also be used as the input module when implemented with the TSP that forms the interlayer structure with the touch pad.

The output module 30 may output information corresponding to a user input and output traveling information of the mobile robot and status information of the mobile robot.

For example, the output module 30 may output error information, and SoC information of the battery.

The output module 30 may include a display module 31 for displaying various information in images and a speaker 32 for outputting various information in sounds.

The display module 31 may be arranged on the top of the main body 1a.

The display module 31 may also display the number of times of charging the battery required to deal with the whole working area and a time required for one-time charging of the battery.

The display module 31 may display an expected working time required to deal with the whole working area and an expected working completion time.

The display module 31 may include a cathode ray tube (CRT), a digital light processing (DLP) panel, a plasma display panel (PDP), a liquid crystal display (LCD) panel, an electro luminescence (EL) panel, an electrophoretic display (EPD) panel, an electrochromic display (ECD) panel, a light emitting diode (LED) panel, an organic light emitting diode (OLED) panel, etc., but is not limited thereto.

The communicator 40 may receive signals from the charging station 4 and the plurality of beacons 100. The signals from the beacons 100 may be UWB signals.

The communicator 40 may include a plurality of antennas for UWB communication.

The signal from each beacon 100 may include location information of the beacon 100. The signal from the charging station 4 may include location information.

The communicator 40 for receiving signals from the plurality of beacons 100 and the charging station 4 may be implemented with at least one device that is able to receive or read the signals in a short range such as a near field communication (NFC) module, a radio frequency identification (RFID) reader, etc.

The communicator 40 may include one or more components that enable communication with an external device, for example, at least one of a short-range communication module, a wired communication module, and a wireless communication module. In this case, the external device may include the user equipment 2, the server 3, the charging station 4 and the plurality of beacons 100, and may further include a router.

The communicator 40 may depend on a communication scheme of another device or a server to communicate with.

The short-range communication module may include various short range communication modules for transmitting and receiving signals within a short range over a wireless communication network, such as Bluetooth module, an infrared communication module, a radio frequency identification (RFID) communication module, a wireless local access network (WLAN) communication module, a near field communication (NFC) module, a Zigbee communication module, etc.

The wired communication module may include not only one of various wired communication modules, such as a local area network (LAN) module, a wide area network (WAN) module, or a value-added network (VAN) module, but also one of various cable communication modules, such as a universal serial bus (USB), a high-definition multimedia interface (HDMI), a digital visual interface (DVI), recommended standard (RS) 232, a power cable, or a plain old telephone service (POTS).

The wireless communication module may include a wireless fidelity (Wi-Fi) module, a wireless broadband (Wibro) module, and/or any wireless communication device for supporting various wireless communication schemes, such as a global system for mobile communication (GSM) module, a code division multiple access (CDMA) module, a wideband code division multiple access (WCDMA) module, a universal mobile telecommunications system (UMTS), a time division multiple access (TDMA) module, a long term evolution (LTE) module, etc.

The wireless communication module may include a wireless communication interface that includes an antenna and a transmitter for transmitting signals of the beacons 100. Furthermore, the wireless communication module may further include a first signal conversion module for modulating a digital control signal output from the processor through the wireless communication interface to an analog wireless signal under the control of the at least one processor.

The wireless communication module may include the wireless communication interface that includes an antenna and a receiver for receiving signals of the beacons 100. Furthermore, the wireless communication module may further include a second signal conversion module for demodulating an analog wireless signal received through the wireless communication interface into a digital control signal.

The processor 50 controls general operation of the mobile robot 1. There may be one, two or more processors 50. In other words, there may be at least one processor 50.

The processor 50 uses data stored in the memory 51 to control operations of the mobile robot 1.

The processor 50 controls autonomous traveling, docking and mowing of the mobile robot 1.

The processor 50 may process a sensor signal from the sensor module 10 and process signals from the input module 20 and the communicator 40.

The processor 50 may receive a user input from the user equipment 2 and control operations of the mobile robot based on the received user input, and may also transmit operation information of the mobile robot 1 to the user equipment 2 to display the operation information of the mobile robot 1 through the user equipment 2.

The processor 50 may control an output of the output module 30.

The processor 50 may control the blade to be as high as a preset height or a height corresponding to a user input.

The processor 50 may transmit control signals for the first motors 1d to the first motor driver 60 to control operations of the plurality of first motors 1d and second motor 1e, and transmit a control signal for the second motor 1e to the second motor driver 70.

The processor 50 may control charging of the battery 80.

The related operations of the processor 50 will be described in more detail.

The processor 50 may control autonomous traveling of the mobile robot 1 based on sensing signals received from the sensors of the sensor module 10.

The processor 50 may determine whether there is an obstacle based on a sensing signal received from the first sensor 11, obtain the obstacle information based on the sensing information when determining that there is an obstacle, recognize a shape of the obstacle and a distance and direction to the obstacle based on the obtained obstacle information, and control autonomous traveling while avoiding the obstacle based on the information about the shape of the obstacle and the information about the distance and direction to the obstacle.

The processor 50 may obtain image information of the working area and image information of the obstacle based on the sensing signal received from the second sensor 12, and control autonomous traveling while avoiding the obstacle in the working area based on the image information of the working area and the image information of the obstacle.

The processor 50 may check SoC information of the battery 80 based on the sensing signal received from the third sensor 13, determine a need to charge the battery based on the SoC information of the battery 80, communicate with the charging station 4 when determining that the battery needs to be charged, and control docking with the charging station 4 based on the communication information with the charging station 4.

On receiving a command to start mowing, the processor 50 may obtain information about a work amount allowed for mowing based on the SoC information of the battery 80 and control the display module 31 to display the information about the work amount.

When determining that the battery 80 needs to be charged during the mowing, the processor 50 may control the output module 30 to output information notifying a need for charging and control docking with the charging station 4.

The processor 50 may also receive SoC information of the battery 80 from the battery manager 81.

The processor 50 may obtain traveling speed information of the mobile robot 1 based on the rotation speed of the first motor 1d connected to the wheels 1b arranged on the left and right of the main body 1a.

The processor 50 may obtain rotation speed of the first motor 1d based on a sensing signal received from the fourth sensor 14 during the mowing, obtain a control signal for the first motor 1d based on the rotation speed of the first motor 1d and a target rotation speed of the first motor 1d, and transmit the control signal for the first motor 1d to the first motor driver 60.

The processor 50 may obtain target rotation speeds of a first motor da connected to a left wheel ba and a first motor db connected to a right wheel bb based on a traveling direction of the mobile robot, transmit a control signal corresponding to the target rotation speed of the first motor da connected to the left wheel ba to the first motor driver to control the first motor da connected to the left wheel ba, and transmit a control signal corresponding to the target rotation speed of the first motor db connected to the right wheel bb to the first motor driver to control the first motor db connected to the right wheel bb.

The processor 50 may obtain rotation speed of the second motor 1e based on a sensing signal received from the fifth sensor 15 during the mowing, obtain a control signal for the second motor 1e based on the rotation speed of the second motor 1e and a target rotation speed of the second motor 1e, and transmit the control signal for the second motor 1d to the second motor driver 70.

Referring to FIG. 4, the processor 50 may control communication with the plurality of beacons 100 and the charging station 4, and create location coordinates corresponding to the boundary of the working area based on the location information received from the charging station 4 and location information of the plurality of beacons 100 received from the beacons 100.

The processor 50 may set the location information of the charging station 4 as reference location information.

The processor 50 may create coordinates (0, 0, 0) for the reference location information, and create coordinates (x1, y1, z1), (x2, y2, z2), and (x3, y3, z3) of the plurality of beacons based on the set reference location information.

The processor 50 may create coordinates and a map of the working area based on the set reference location information, and control the mobile robot 1 to travel based on the map.

The processor 50 may control communication with the plurality of beacons 100 and the charging station 4, obtain information about a distance do and direction to the charging station 4 based on signals transmitted or received to or from the charging station 4 and signals transmitted or received to or from the plurality of beacons 100, obtain information about distances d1, d2 and d3 and directions to the plurality of beacons 100, and recognize current location information of the mobile robot 1 based on the information about the distance do and direction to the charging station and the information about the distances d1, d2 and d3 and directions to the plurality of beacons 100.

The processor 50 may use UWB communication based simultaneous localization and mapping (SLAM) to recognize the current location of the mobile robot. Specifically, when the mobile robot 1 travels several times (or one time) in the working area, the processor 50 may recognize the map of the working area and the location of the mobile robot 1 based on a SLAM algorithm.

On receiving a command to start mowing from the input module 20, the processor 50 may control traveling and cutting operations of the mobile robot based on the recognized current location of the mobile robot.

The processor 50 may control the traveling and cutting operations of the mobile robot to be stopped when receiving a command to pause mowing from the input module 20.

The processor 50 may control the traveling and cutting operations of the mobile robot to be stopped and control docking with the charging station 4, when receiving a command to stop mowing from the input module 20.

The processor 50 may control the output module 30 to output traveling information of the mobile robot and status information of the mobile robot.

The processor 50 may control the speaker 32 to output information notifying a need for charging the battery in sound, and control the speaker 32 to output information notifying start and stop mowing in sound.

The processor 50 may control the speaker 32 to output information notifying a failure of the mobile robot in sound.

On receiving a command to start mowing, the processor 50 may receive position information of the charging station from the charging station and store the position information of the charging station. The position information of the charging station may include the information about a distance to the mobile robot and the information about a direction to the mobile robot obtained by the charging station.

The processor 50 may control traveling of the mobile robot when receiving the command to start mowing. In this case, the mobile robot may be separated from the charging station.

The processor 50 may control departure of the mobile robot.

To control the departure of the mobile robot, the processor 50 may check sensing information detected by the sixth sensor 16 and recognize a motion of the mobile robot based on the sensing information.

The processor 50 may obtain information about the distance and direction to the charging station 4, correct the sensing information based on the information about the distance and direction to the charging station 4, and recognize a motion of the mobile robot based on the corrected sensing information.

As shown in FIG. 11A, to control departure of the mobile robot 1, the processor 50 may check information about a travel distance of the mobile robot 1, obtain direction information of the mobile robot when determining that the travel distance DD of the mobile robot corresponds to a preset distance based on the information about the travel distance, and correct the sensing information detected by the sixth sensor 16 based on the direction information of the mobile robot.

The information about the traveled distance may be information about a distance traveled straight in the forward direction.

The direction information of the mobile robot may include angle information of the mobile robot.

To control departure of the mobile robot 1, the processor 50 may control communication with the plurality of beacons 100, obtain movement information of the mobile robot 1 based on signals received from the plurality of beacons 100, and obtain information about a traveled distance and direction of the mobile robot 1 based on the movement information.

The processor 50 may determine whether the mobile robot 1 has moved straight based on the movement information of the mobile robot 1.

To control departure of the mobile robot 1, the processor 50 may control communication with the charging station 4, obtain movement information of the mobile robot 1 based on a signal received from the charging station 4, and obtain information about a traveled distance and direction of the mobile robot 1 based on the movement information.

The processor 50 may count time that has passed from the departure time and obtain information about a traveled distance based on the information about the time counted and the rotation speed information of the first motor.

To control departure of the mobile robot 1, the processor 50 may store sensing information of the sixth sensor 16 corrected after a preset distance of traveling as initial sensing information.

The first sensing information may correspond to angle information of the mobile robot based on the charging station.

The processor 50 may correct the sensing information detected by the sixth sensor 16 based on the movement information of the mobile robot while the robot is traveling and the correction on the sensing information detected by the sixth sensor 16 may be made periodically.

The processor 50 may recognize information about coordinates of the location and angle of the mobile robot in the map of the working area based on the corrected sensing information of the sixth sensor 16.

The processor 50 may check the information about coordinates of the location and angle of the mobile robot obtained from signals transmitted and received to and from the charging station 4 and the respective beacons 100, determine whether the angle information checked matches angle information of the mobile robot detected by the sixth sensor 16, and correct the sensing information detected by the sixth sensor 16 based on the angle information checked when it is determined that the two angles are different.

The correcting of the sensing information detected by the sixth sensor 16 includes correcting the angle information of the mobile robot corresponding to the sensing information detected by the sixth sensor 16.

The processor 50 may also obtain a cumulative distance of the mobile robot based on the information about the traveled distance of the mobile robot, obtain corrected angle information corresponding to the cumulative distance obtained, and correct the sensing information detected by the sixth sensor 16 based on the corrected angle information. The corrected angle information corresponding to the cumulative distance may be obtained experimentally and stored in advance.

As shown in FIG. 11B, the processor 50 may determine whether communication with at least one of the plurality of beacons is not possible, and control the main body 1a of the mobile robot to be rotated 360 degrees when it is determined that communication with the at least one beacon is not possible.

The processor 50 controls communication between the first, second and third robot antennas 40a, 40b and 40c and the first and second station antennas of the charging station while controlling rotation of the main body 1a of the mobile robot.

The processor 50 may obtain direction information of the mobile robot based on signals received through the first, second and third robot antennas 40a, 40b and 40c, and correct the sensing information detected by the sixth sensor 16 based on the direction information obtained.

The processor 50 may obtain information about a distance and direction to the charging station 4 based on signals received through the first and second robot antennas 40a and 40b, and obtain information about a distance and direction to the charging station 4 based on signals received through the second and third robot antennas 40b and 40c. The information about a direction to the charging station 4 may include information about an angle with the charging station.

The processor 50 may obtain information about left and right directions of the mobile robot based on a phase difference between signals received through the first and second robot antennas 40a and 40b, and obtain information about front and rear directions of the mobile robot with respect to the charging station based on a phase difference between signals received through the second and third robot antennas 40b and 40c.

The processor 50 may recognize information about an angle with the charging station through an AOA positioning technology and correct the sensing information detected by the sixth sensor 16 based on the recognized angle information.

The correcting of the sensing information detected by the sixth sensor 16 may include correcting information about a motion of the mobile robot. The correcting of the sensing information detected by the sixth sensor 16 may include correcting information about an angle of the mobile robot.

The processor 50 may control docking when receiving a command to stop mowing.

The processor 50 may determine whether the mowing is done, and control docking when it is determined that the mowing is done.

Furthermore, the processor 50 may control docking when determining that the battery 80 needs to be charged. In other words, when determining that a charge level of the battery 80 corresponds to a reference charge level or less, the processor 50 may determine that charging is required.

To control docking, the processor 50 may control traveling to charging station 4 having the reference location information.

In controlling docking, the processor 50 obtains information about a distance and direction to the charging station 4 based on signals received from the charging station 4 and the plurality of beacons 100, obtains information about distances and directions to the respective beacons 100, and recognizes current location information of the mobile robot based on the information about the distance and direction to charging station 4 and the information about the distances and directions to the respective beacons 100.

The information about the distance to the charging station 4 may be information about a relative distance to the charging station 4.

The information about the direction to the charging station 4 may be information about a relative direction to the charging station and may include information about a relative angle with the charging station 4.

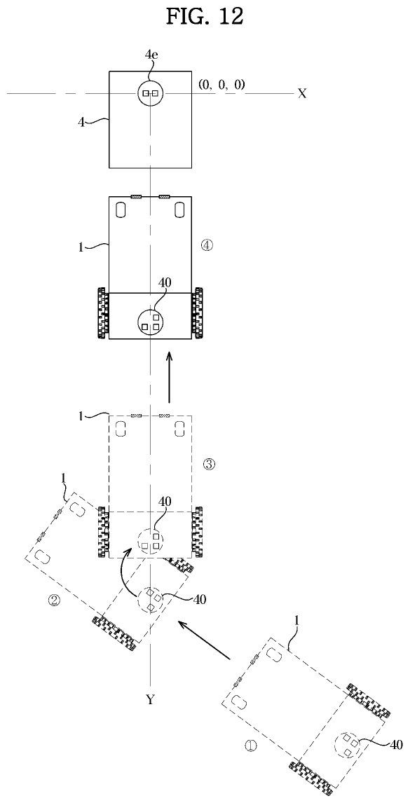

As shown in FIG. 12, the processor 50 may control docking based on the recognized current location information and the location information of the charging station 4.

To control docking, the processor 50 may control traveling until the distance to the charging station 4 reaches the reference distance.

Assuming that the horizontal axis of the charging station 4 corresponding to a direction in which the third and fourth charging terminals are arranged is defined to be the X-axis and the vertical axis of the charging station is defined to be the Y-axis, the processor 50 may control the first motor to travel to a location with a value of the X-axis having 0 and a value of the Y-axis corresponding to the value of the reference distance.

The location with the value of the X-axis having 0 may be a location between the third and fourth charging terminals of the charging station.

The location with the value of the X-axis having 0 may be at a middle location between the third and fourth charging terminals of the charging station.

The processor 50 may control traveling so that the middle location between the first and second charging terminals comes to the location with the value of the X-axis of the charging station having 0.

The processor 50 may control traveling so that the locations of the first, second and third robot antennas of the communicator correspond to the location with the value of the X-axis of the charging station having 0.

It is also possible that the processor 50 controls the first motor to travel to a location with a value of the Y-axis being larger than the value of the reference distance.

The value of the reference distance may be a value of distance that the mobile robot is able to rotate without conflicting with the charging station.

The value of the reference distance may be a value corresponding to a longer distance than a length L4 of the main body of the mobile robot.

The processor 50 may control traveling of the mobile robot to a location at which a third distance L3 between a charging electrode of the charging station and the mobile robot corresponds to a distance longer than the length L4 of the main body of the mobile robot.

The processor 50 may control rotation of the main body 1a to align the charging station and the mobile robot. In this case, the processor 50 may control rotation of the main body 1a so that the third and fourth terminals of the charging station 4 are aligned with the first and second charging terminals of the mobile robot 1.

For example, the processor 50 may control the main body 1a to be rotated by an angle of about 90 degrees.

When the rotation of the main body 1a is completed, the processor 50 controls traveling of the mobile robot based on the relative distance information and controls rotation of the mobile robot based on the relative angle information.

At the time of departure of the mobile robot, the processor 50 may control docking by controlling rotation of the main body of the mobile robot based on location information of the charging station, initial angle information of the charging station and the current angle information of the mobile robot stored.

The processor 50 may determine whether it is not possible to communicate with at least one of the plurality of beacons while controlling the docking.

When determining that no signal is received from the at least one of the plurality of beacons, the processor 50 may determine that it is not possible to communicate with the at least one beacon.

When determining that an error signal is received from the at least one of the plurality of beacons, the processor 50 may determine that it is not possible to communicate with the at least one beacon.

The processor 50 may determine a location error between the current location information of the mobile robot in the map and the current location information of the mobile robot obtained through the plurality of beacons, and determine that communication with the plurality of beacons is not possible when determining that the location error goes beyond a reference error.

When determining that communication with at least one beacon is not possible, the processor 50 may control the first, second and third robot antennas of the communicator to use the first, second and third robot antennas 40a, 40b and 40c of the communicator 40 to transmit and receive signals with the first and second station antennas of the charging station.

The processor 50 may obtain information about a distance and direction to the charging station based on signals received through the first and second robot antennas 40a and 40b, and obtain information about a distance and direction to the charging station based on signals received through the second and third robot antennas 40b and 40c.

The processor 50 may obtain information about left and right directions of the mobile robot based on a phase difference between signals received through the first and second robot antennas 40a and 40b, and obtain information about front and rear directions of the mobile robot with respect to the charging station based on a phase difference between signals received through the second and third robot antennas 40b and 40c.

The processor 50 may control docking based on the information about the direction and distance to the station.

The memory 51 stores an algorithm for controlling operations of the components in the mobile robot 1 or data for a program that represents the algorithm.

The memory 51 may store a map of SoC information corresponding to the voltage of the battery, store a map of SoC information of the battery corresponding to the voltage and current of the battery, and store a map of SoC information of the battery corresponding to the voltage, current and temperature of the battery.

The memory 51 stores information about a reference charging level to determine a need for charging the battery.

The memory 51 may adjust information about a preset travel distance required to correct the sensing information of the sixth sensor and a reference distance required to control docking.

The memory 51 may store location information of the charging station, direction information of the charging station and location information of the beacons 100. The location information may be location coordinate information.

The memory 51 may store a first map of information about discharge amounts of the battery consumed for simultaneous operations of the first motors 1d and the second motor 1e and a second map of information about discharge amounts of the battery consumed for operations of the first motors 1d. The information about the discharge amount of the battery may be SoC information of the battery.

The memory 51 may store a target rotation speed of the first motor da connected to the left wheel ba and a target rotation speed of the first motor db connected to the right wheel bb corresponding to a traveling direction of the mobile robot.

The memory 51 may store a target rotation speed of the first motor da connected to the left wheel ba and a target rotation speed of the first motor db connected to the right wheel bb corresponding to a rotation angle of the mobile robot 1.

The memory 51 may be implemented with at least one of a non-volatile memory device, such as cache, read only memory (ROM), programmable ROM (PROM), erasable programmable ROM (EPROM), electrically erasable programmable ROM (EEPROM), a volatile memory device, such as random-access memory (RAM), or a storage medium, such as hard disk drive (HDD) or compact disk (CD) ROM, without being limited thereto.

The memory 51 and the processor 50 may be implemented in separate chips. Alternatively, the memory 51 and the processor 50 may be implemented in a single chip.

The first motor driver 60 may be connected to the plurality of first motors 1d.

The first motor driver 60 may control the plurality of first motors in response to a control instruction from the processor 50.

The first motor driver 60 may rotate the plurality of first motors 1d at the same or different target rotation speeds in response to a control instruction from the processor 50.

The first motor driver 60 may include an inverter.

The second motor driver 70 may be connected to the second motor 1e.

The second motor driver 70 may rotate the second motor 1e at the target rotation speed of the second motor 1e in response to a control instruction from the processor 50.

The second motor driver 70 may include an inverter.

The battery 80 supplies power required for operation of the mobile robot.

The battery 80 may be connected directly or indirectly to the first and second charging terminals 1f and 1g arranged in the main body 1a.

The battery 80 may be a rechargeable battery. The battery 80 may be charged while the mobile robot 1 docks at the charging station 4.

The battery manager 81 may monitor an SoC of the battery 80 and transmit information about the SoC to the processor 50.

The battery manager 81 may include a voltage sensor for detecting the voltage of the battery, a current sensor for detecting the current to the battery, and a temperature sensor for detecting the temperature of the battery, and monitor the SoC of the battery based on the voltage, current and temperature of the battery.

The battery manager 81 may determine based on the SoC information of the battery 80 whether charging of the battery 80 is completed, and transmit charging completion information to the processor 50 when determining that charging of the battery 80 is completed.

At least one component may be added or omitted to correspond to the performance of the components of the mobile robot shown in FIG. 8. Furthermore, it will be obvious to those of ordinary skill in the art that the relative positions of the components may be changed to correspond to the performance or structure of the mobile robot.

The components shown in FIG. 8 may refer to software, or hardware components such as Field Programmable Gate Arrays (FPGAs) and Application Specific Integrated Circuits (ASICs).

Meanwhile, the embodiments of the disclosure may be implemented in the form of a recording medium for storing instructions to be carried out by a computer. The instructions may be stored in the form of program codes, and when executed by a processor, may generate program modules to perform operations in the embodiments of the disclosure. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

The embodiments of the disclosure have thus far been described with reference to accompanying drawings. It will be obvious to those of ordinary skill in the art that the disclosure may be practiced in other forms than the embodiments of the disclosure as described above without changing the technical idea or essential features of the disclosure. The above embodiments of the disclosure are only by way of example, and should not be construed in a limited sense.

1. A mobile robot comprising:
a main body;
a plurality of antennas in the main body; and
at least one processor configured to:
receive, through the plurality of antennas, a communication signal from a charging station,
obtain information about a distance between the charging station and the mobile robot and information about a direction from the mobile robot to the charging station based on the received communication signal,
receive information about a position of the charging station from the charging station, and
control docking of the mobile robot at the charging station based on the obtained information about the distance between the charging station and the mobile robot, the obtained information about a direction from the mobile robot to the charging station, and the received information about a position of the charging station.

2. The mobile robot of claim 1, wherein
the plurality of antennas are configured to:
receive, from a plurality of beacons, a plurality of communication signals respectively corresponding to the plurality of beacons, and
the at least one processor is further configured to:
set up a boundary of a working area, create a map of the working area, and recognize current location information of the mobile robot based on the received plurality of communication signals and the communication signal received from the charging station.

3. The mobile robot of claim 2, wherein during the control of docking the at least one processor is further configured to:
determine, based on the recognized current location information of the mobile robot, whether the distance between the charging station and the mobile robot corresponds to a reference distance,
control a rotation of the main body, based on the obtained information about the direction from the mobile robot to the charging station, to align the main body with the charging station by a time when the distance between the charging station and the mobile robot is determined to equal the reference distance, and
control travel of the mobile robot based on the obtained information about the distance between the charging station and the mobile robot.

4. The mobile robot of claim 1, further comprising:
a first charging terminal in the main body; and
a second charging terminal in the main body and spaced apart a first distance from the first charging terminal,
wherein the plurality of antennas are arranged in a region between the first charging terminal and the second charging terminal, and in an area extending from the region between the first charging terminal and the second charging terminal.

5. The mobile robot of claim 1, wherein the plurality of antennas are disposed on an upper surface of the main body or protrude from the upper surface of the main body.

6. The mobile robot of claim 1, wherein
the plurality of antennas include a first robot antenna, a second robot antenna, and a third robot antenna,
the first robot antenna is separated from each of the second robot antenna and the third robot antenna by a distance less than or equal to a half wavelength of an ultra-wideband communication frequency, and
the second robot antenna and the third robot antenna are arranged perpendicularly to each other with respect to the first robot antenna so that the first robot antenna, the second robot antenna, and the third robot antenna, are disposed at vertices of a triangle.

7. The mobile robot of claim 6, wherein
the plurality of antennas are configured to communicate with a plurality of beacons, and
the at least one processor is further configured to:
determine that communication between the plurality of antennas and the plurality of beacons is not possible, and
based on the determination:
receive, through the first robot antenna, the second robot antenna, and the third robot antenna, a plurality of communication signals from the charging station, and
recognize current location information of the mobile robot based on the received plurality of communication signals.

8. The mobile robot of claim 6, further comprising:
a sensor configured to detect a motion of the main body,
wherein
the plurality of antennas are configured to communicate with a plurality of beacons, and
the at least one processor is further configured to:
determine that communication between the plurality of antennas and the plurality of beacons is not possible, and
based on the determination:
receive, through the first robot antenna, the second robot antenna, and the third robot antenna, a plurality of communication signals from the charging station,
control a 360-degree rotation of the main body, and
correct sensing information detected by the sensor based on the received plurality of communication signals while controlling the 360-degree rotation of the main body.

9. The mobile robot of claim 1, further comprising:
a sensor configured to detect a motion of the main body,
wherein the at least one processor is further configured to:
correct sensing information detected by the sensor based on the obtained information about the distance between the charging station and the mobile robot and the obtained information about the direction from the mobile robot to the charging station.

10. The mobile robot of claim 1, further comprising:
a sensor configured to detect a motion of the main body,
wherein
the plurality of antennas are configured to communicate with a plurality of beacons, and
the at least one processor is further configured to:
receive, through the plurality of antennas, a plurality of first communication signals respectively corresponding to the plurality of antennas from the charging station,
receive, through the plurality of antennas, a plurality of second communication signals respectively corresponding to the plurality of beacons from the plurality of beacons,
determine based on the received plurality of first communication signals and the received plurality of second communication signals whether the mobile robot has traveled a preset distance in a straight line from the charging station, and
correct sensing information detected by the sensor based on the determination.

11. A motion control system comprising:
a charging station including a plurality of station antennas configured to transmit and/or receive one or more first communication signals for setting up a boundary of a working area and transmit position information of the charging station;
a plurality of beacons configured to transmit and/or receive one or more second communication signals for setting up the boundary of the working area; and
a mobile robot including a plurality of robot antennas configured to communicate with the charging station and the plurality of beacons, and travel in the working area,
wherein the mobile robot is configured to:
receive, through the plurality of robot antennas, the one or more first communication signals from the charging station,
obtain information about a distance between the charging station and the mobile robot and information about a direction from the mobile robot to the charging station based on the one or more received first communication signals,
receive the position information of the charging station from the charging station, and
control docking of the mobile robot at the docking station based on the obtained information about the distance between the charging station and the mobile robot, the obtained information about the direction from the mobile robot to the charging station, and the received position information of the charging station.

12. The motion control system of claim 11, wherein the mobile robot is further configured to:
receive, through the plurality of robot antennas, the one or more second communication signals respectively corresponding to the plurality of beacons, and
set up the boundary of the working area, create a map of the working area, and recognize current location information of the mobile robot based on the received one or more second communication signals and the received one or more first communication signals.

13. The motion control system of claim 12, wherein during the control of docking the mobile robot is further configured to:
determine, based on the recognized current location information of the mobile robot, whether the distance between the charging station and the mobile robot corresponds to a reference distance,
control a rotation of a main body of the mobile robot, based on the obtained information about the direction from the mobile robot to the charging station, to align the main body with the charging station by a time when the distance between the charging station and the mobile robot is determined to equal the reference distance,
control travel of the mobile robot based on the obtained information about the distance to the charging station, and
the charging station is configured to:
receive, through the plurality of station antennas, in response to a departure of the mobile robot from the charging station, the one or more first communication signals from the mobile robot,
obtain the information about the distance between the charging station and the mobile robot and information about a direction from the charging station to the mobile robot based on the received one or more first communication signals, and
set the information about the distance between the charging station and the mobile robot and the information about the direction from the mobile robot to the charging station as the position information of the charging station.

14. The motion control system of claim 11, wherein
the plurality of robot antennas are separated from one another by a distance less than or equal to a half wavelength of an ultra-wideband communication frequency, and
the mobile robot is further configured to:
determine that communication with the plurality of beacons is not possible, and
based on the determination:
recognize current location information based on the one or more first communication signals.

15. The motion control system of claim 11, further comprising:
a sensor arranged in the mobile robot and configured to detect a motion of the mobile robot,
wherein the mobile robot is further configured to:
determine whether communication with the plurality of beacons is possible,
based on the determination that communication with the plurality of beacons is not possible:
control a 360-degree rotation of the mobile robot, and
correct sensing information detected by the sensor based on the received one or more first communication signals while controlling the 360-degree rotation of the mobile robot, and
based on the determination that communication with the plurality of beacons is possible:
receive, through the plurality of robot antennas, the one or more second communication signals from the plurality of beacons, and
correct the sensing information detected by the sensor based on the received one or more first communication signals and the one or more second communication signals.

16. The mobile robot of claim 1, further comprising:
a motor fixed in the main body and having a driving axis; and
at least one blade connected to the motor and rotatable about the driving axis, wherein the motor is configured to generate a driving power to rotate the at least one blade while the mobile robot travels.
